(19) United States
(12) Patent Application Publication
(10) Pub. No.: US 2023/0129529 A1
(43) Pub. Date: Apr. 27, 2023

(54) MULTI-COMPARTMENT PACKAGE

(71) Applicant: Reckitt Benckiser Finish B.V., Hoofddorp (NL)

(72) Inventors: Alias Younis AL-BAYATI, Heidelberg (DE); Francesc Ardite AYATS, Barcelona (ES); Ralf HOFSÄSS, Heidelberg (DE); Jörg Peter PFLUG, Heidelberg (DE); Torsten ROTH, Heidelberg (DE); Claudia SCHMAELZLE, Heidelberg (DE); Christian SCHNEEWEISS, Heidelberg (DE); Boris SEITZ, Heidelberg (DE)

(73) Assignee: Reckitt Benckiser Finish B.V., Hoofddorp (NL)

(21) Appl. No.: 17/509,506

(22) Filed: Oct. 25, 2021

(51) Int. Cl. C11D 17/04; C11D 11/00

(52) U.S. Cl. CPC C11D 17/045; C11D 11/0023

(57) ABSTRACT

A multi-compartment package for an automatic dishwashing cycle, the multi-compartment package comprising an external sealing web extending around a periphery of the package, and an internal sealing web which partitions the package to form a first compartment comprising a first detergent composition in the form of a solid, a second compartment comprising a second detergent composition in the form of a non-solid, and a third compartment comprising a third detergent composition in the form of a non-solid having a viscosity lower than the viscosity of the second detergent composition, wherein the internal sealing web comprises at least a first internal sealing region arranged across the package to partition the first compartment and the second compartment, and a second internal sealing region arranged across the package to partition the second compartment and the third compartment, wherein the first detergent composition is separated from the third detergent composition by the first internal sealing region, the second compartment and the second internal sealing region.

### TECHNICAL FIELD OF THE INVENTION

The present invention relates to a multi-compartment package. The invention further relates to the use of a multi-compartment package and to a packaging unit comprising a plurality of multi-compartment packages.

### BACKGROUND TO THE INVENTION

Multi-compartment packages, such as multi-compartment packages for an automatic dishwashing cycle, are known. Typically, such packages comprise a first compartment comprising a solid detergent composition and a second compartment comprising a liquid or gel detergent composition.

By providing a multi-compartment package comprising a solid detergent composition and a liquid or gel detergent composition, there remains a significant risk of inter-compartment leakage of the liquid or gel detergent composition due to rupture of the internal sealing lines which partition adjacent compartments. Inter-compartment leakage of liquid or gel detergent compositions causes significant deterioration of the package aesthetic. Moreover, inter-compartment leakage of the liquid or gel detergent composition may occur into a compartment comprising a solid detergent composition. Such leaking of the liquid or gel detergent composition significantly affects the functionality of the solid detergent composition and the liquid or gel detergent composition due to unwanted reactions between the two detergent compositions.

### BRIEF DESCRIPTION OF THE FIGURES

FIG. 1 shows a Comparative Formulation package.

FIG. 2 shows the Comparative Formulation clamped at its first compartment.

FIG. 3 shows the Comparative Formulation clamped at its second compartment.

FIG. 4 shows a package according to the claimed invention (Inventive Formulation).

FIG. 5 shows the Inventive Formulation clamped at its first compartment.

FIG. 6 shows the Inventive Formulation clamped at its second compartment.

### SUMMARY OF THE INVENTION

According to a first aspect of the invention, there is provided a multi-compartment package for an automatic dishwashing cycle, the multi-compartment package comprising an external sealing web extending around a periphery of the package, and an internal sealing web which partitions the package to form a first compartment comprising at least a first detergent composition in the form of a solid, a second compartment comprising at least a second detergent composition in the form of a non-solid, and a third compartment comprising at least a third detergent composition in the form of a non-solid having a viscosity lower than the viscosity of the second detergent composition, wherein the internal sealing web comprises at least a first internal sealing region arranged across the package to partition the first compartment and the second compartment, and a second internal sealing region arranged across the package to partition the second compartment and the third compartment, wherein the first detergent composition is separated from the third detergent composition by the first internal sealing region, the second compartment and the second internal sealing region.

In some embodiments, the first internal sealing region is a first internal sealing line.

In some embodiments, the second internal sealing region is a second internal sealing line.

The multi-compartment package is useful in any individual stage, or multiple stages, of the dishwashing cycle of an automatic dishwasher. In this specification the term ‘dishwashing cycle’ means the entire dishwashing operation, including a main wash and a rinse stage, a pre-wash, an intermediate stage, and any additional cleaning or rinsing stages.

By the term ‘detergent composition’, it is meant a composition comprising one or more cleaning actives suitable for a dishwashing cycle. A detergent composition may comprise at least one cleaning active selected from the group comprising a builder, co-builder, surfactant, alkalinity source, acidity source, enzyme, polymer, anti-corrosion agent, bleaching agent, perfume, colourant or care agent, or a mixture thereof.

By the term ‘solid detergent composition’, it is meant a detergent composition in solid form at 25° C. and atmospheric pressure, including, for example, a powdered solid, a tablet, a coated granule or a co-granule. The powdered solid may be a compressed powder or a non-compressed powder, or a mixture thereof.

By the term ‘non-solid detergent composition’, it is meant a detergent composition which is in any form other than solid form at 25° C. and atmospheric pressure, for example, a paste, a liquid, a gel or a suspension of powder, granules, coated granules or co-granules within a paste, liquid or gel.

It is known to provide a two- or three-compartment package comprising at least one solid detergent composition and at least one non-solid detergent composition in separate compartments. In known multi-compartment packages, the compartment comprising the at least one solid detergent composition is arranged directly adjacent to, i.e. separated by only a single internal sealing line, one or more compartments comprising a non-solid detergent composition. For example, the compartment comprising the at least one solid detergent composition may be located centrally relative to the confines of the package and may be flanked by two separate compartments, each comprising at least one non-solid detergent composition, arranged directly adjacent to the compartment comprising the at least one solid detergent composition.

It is known that multi-compartment packages comprising detergent compositions are susceptible to inter-compartment leakage of detergent compositions comprised within the two or more compartments of the package. Inter-compartment leakage is a significant problem in packages comprising a compartment comprising at least one solid detergent composition arranged directly adjacent to at least one compartment comprising at least one non-solid detergent composition having a relatively low viscosity, such as a liquid detergent composition.

Disadvantageously, arranging a compartment comprising at least one solid detergent composition directly adjacent to one or more compartments comprising at least one non-solid detergent composition, in particular a compartment comprising a liquid detergent composition, increases the risk of the one or more non-solid detergent compositions leaking into the compartment comprising the solid detergent composition, to the detriment of the package aesthetic and the functionality of the solid detergent composition through unwanted reactions between the solid and non-solid detergent compositions.

Despite the above-mentioned drawbacks, three-compartment detergent packages provide significant performance advantages over two-compartment detergent packages due to their ability to comprise greater quantities of cleaning actives and comprise detergent compositions, for example a solid, a gel and a liquid, which differ in handling and chemical properties, for example their rheological profile, therefore, allowing for unique dissolution profiles of the detergent compositions located within the respective compartments.

Advantageously, the multi-compartment package according to the invention provides for a three-compartment package wherein the compartment comprising the at least one solid detergent composition is arranged directly adjacent to only a single compartment comprising at least one non-solid detergent composition and, therefore, is not arranged directly adjacent to two or more compartments comprising at least one non-solid detergent composition. This significantly reduces the possibility of inter-compartment leakage of a non-solid detergent composition into the compartment comprising the at least one solid detergent composition. As such, the risk of detrimentally affecting the package aesthetic and functionality of the at least one solid detergent composition is significantly reduced, while maintaining the benefits of a three-compartment detergent package.

Further advantageously, the multi-compartment package according to the invention, that is, having a compartment comprising at least one solid detergent composition separated from a compartment comprising at least one non-solid detergent composition having the lowest viscosity of the detergent compositions comprised in the package by a first and a second internal sealing line and a second compartment, further significantly reduces the possibility of leakage of the at least one non-solid detergent composition into the compartment comprising the at least one solid detergent composition. As such, the present invention provides for a multi-compartment package comprising a compartment comprising the at least one solid detergent composition which is not arranged directly adjacent to the compartment comprising the non-solid detergent composition having the lowest viscosity of the detergent compositions comprised in the package. Thus, the risk of inter-compartment leakage of the at least one non-solid detergent composition having the lowest viscosity is significantly reduced. As such, the risk of detrimentally affecting the package aesthetic and functionality of the at least one solid detergent composition is significantly reduced, while maintaining the benefits of a three-compartment detergent package.

The multi-compartment package according to the invention, therefore, maintains a favourable package aesthetic and functionality of the at least one solid detergent composition. As such, the multi-compartment package maintains a satisfactory and appealing aesthetic and performance profile, in-line with the consumer’s expectations.

The third detergent composition may comprise at least one liquid detergent composition or at least one gel detergent composition.

Gels are generally defined as a non-fluid colloidal network or polymer network that is expanded throughout its whole volume by a fluid, with hydrogels having water as the expanding or swelling agent. Herein, the term gel is not limited to a strictly colloidal composition and for the purposes of the invention the term gel may comprise a gel-like thickened liquid. The term ‘gel-like’ may refer to a combination of liquid and solid, or a suspension of solid-in-liquid, that has the appearance and/or consistency of a gel. A gel or gel-like material may have a viscosity at low shear rates (i.e. 0.1 s⁻¹) of greater than 3.5 Pa·s at 25° C. and atmospheric pressure; for example as recorded on a research rheometer with a Brookfield V73 vane in a small concentric cylinder system.

Advantageously, the third detergent composition comprising at least one liquid detergent composition or at least one gel detergent composition provides for a tailored package allowing for at least three substantially different detergent compositions which differ in handling and chemical properties, for example their rheological profile, therefore, allowing for unique dissolution profiles of the detergent compositions located within the respective compartments, while significantly reducing inter-compartment leakage of the third detergent composition into the solid detergent composition, and, therefore, maintaining a favourable package aesthetic and functionality.

The second compartment may comprise a gel detergent composition.

The internal sealing web may have a total area of less than about 140 mm².

Advantageously, an internal sealing web having a total area of less than about 140 mm² further reduces the risk of inter-compartment leakage of any non-solid detergent compositions comprised in the multi-compartment package, for example the second detergent composition or the third detergent composition. This is because, typically, it is the internal sealing line(s) of a multi-compartment package which is prone to rupture (for example through the formation of microchannels between compartments) during transport or storage of the package, causing leakage of a detergent composition. By minimising the total area of the internal sealing web, i.e. to less than 140 mm², the risk of inter-compartment leakage is further reduced.

The internal sealing web may have a total area of less than about 140 mm², about 138 mm², about 136 mm², about 134 mm², about 132 mm², about 130 mm², about 128 mm², about 126 mm², or less than about 124 mm².

The internal sealing web may have a total area of between about 80 and about 140 mm², between about 90 and about 140 mm², between about 100 and about 130 mm², between about 108 and about 122 mm², or between about 112 and about 118 mm².

The internal sealing web may have a total area of at least about 90 mm², about 100 mm², about 110 mm², or at least about 115 mm².

The external sealing web may have a total area of less than about 355 mm².

It is known that the external sealing web of a detergent package may also be prone to rupture during transport or storage of the package. Rupture of the external sealing web causes the detergent composition adjacent to the point of rupture to leak out of the package. Disadvantageously, such rupturing of the external sealing web causes the package to lose significant amounts of detergent composition, therefore, affecting the performance of the package and the package aesthetic and handling. Moreover, leakage of a detergent composition out of the package affects the performance and aesthetic of packages stored adjacent to the ruptured package during transport and storage.

Advantageously, an external sealing web having a total area of less than about 355 mm² reduces the risk of any detergent compositions comprised in the multi-compartment package, for example the second detergent composition or the third detergent composition, leaking out of the package.

The external sealing web may have a total area of less than about 355 mm², about 350 mm², about 346 mm², about 342 mm², about 338 mm², or less than about 336 mm².

The external sealing web may have a total area of no more than about 280 mm², about 290 mm², about 300 mm², about 310 mm², about 320 mm², about 330 mm², or no more than about 340 mm²

The external sealing web may have a total area of between about 250 and about 355 mm², between about 270 and about 350 mm², between about 290 and about 346 mm², between about 310 and about 342 mm², between about 320 and about 339 mm², or between about 330 and about 337 mm².

The multi-compartment package may comprise a total area of the external sealing web and a total area of the internal sealing web in a ratio of between about 2.55:1 and about 3.55:1.

Advantageously, it has been found that a multi-compartment package according to the invention comprising a total area of the external sealing web and a total area of the internal sealing web present in a ratio of between about 2.55:1 and about 3.55:1 provides a significantly reduced risk of leakage of detergent compositions, in particular non-solid detergent compositions, comprised within the multi-compartment package, compared to a multi-compartment package comprising a total area of the external sealing web and a total area of the internal sealing web present in a ratio of less than 2.55:1.

The total area of the external sealing web and the total area of the internal sealing web may be present in a ratio of between about 2.55:1 and about 3.55:1between about 2.65:1 and about 3.45:1, between about 2.75:1 and about 3.35:1, between about 2.82:1 and about 3.25:1, between about 2.86:1 and about 3.15:1, between about 2.89:1 and about 3.05:1, between about 2.90:1 and about 3.00:1, between about 2.91:1 and about 2.96:1, between about 2.91:1 and about 2.94:1, or about 2.92:1.

The total area of the external sealing web and the total area of the internal sealing web may be present in a ratio of at least about 2.55:1, about 2.65:1, about 2.75:1, about 2.85:1, about 2.95:1, about 3.00:1, about 3.05:1, about 3.10:1, about 3.15:1 about 3.20:1, about 3.25:1, or at least about 3.30:1.

The multi-compartment package may be a water-soluble multi-compartment package.

By the term ‘water-soluble package’ as used herein, it is meant a multi-compartment package which at least partially dissolves in water or disperses in water at 20° C. within 10 minutes to allow for egress of the contents of the multi-compartment package into the surrounding water.

The water-soluble multi-compartment package may be formed of a water-soluble film. The water-soluble film may be rigid or flexible at room temperature.

The water-soluble multi-compartment package may comprise or may be made of a poly(vinyl alcohol) (PVOH) film. The PVOH film may be partially or fully alcoholised or hydrolysed, for example, it may be from 40 to 100%, preferably 70 to 92%, most preferably about 85% to about 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water. The film may be cast, blown or extruded. It may further be unoriented, mono-axially oriented or bi-axially oriented.

The external sealing web and/or the internal sealing web may be formed from fusing a first and second sheet of water-soluble film during manufacture of the multi-compartment package.

Fusing may be in the form of thermoforming.

The water-soluble film may comprise a poly(vinyl alcohol) film. The poly(vinyl alcohol) film may be a thermoformed poly(vinyl alcohol) film.

The external sealing web may comprise a width of at least about 1 mm, about 1.4 mm, about 1.8 mm, or at least about 2.0 mm.

The external sealing web may comprise a width of no more than about 3.0 mm, about 2.6 mm, about 2.2 mm, or no more than about 2.0 mm.

The external sealing web may have a width of between about 1.0 mm and about 3.0 mm, or between about 1.4 mm and about 2.6 mm.

The internal sealing web may have a width of between about 0.8 mm and about 3.0 mm, or between about 1.6 mm and about 2.4 mm.

The internal sealing web may comprise a width of at least about 1 mm, about 1.4 mm, or about 1.8 mm.

The internal sealing web may comprise a width of no more than about 3.0 mm, about 2.6 mm, about 2.2 mm, or no more than about 1.8 mm.

The external sealing web may be moulded flat, or substantially flat, around the periphery of the multi-compartment package.

The external sealing web may lie in a sealing plane (x-y plane) such that each of the compartments of the multi-compartment package extend above and/or below (z-direction) the sealing plane when viewed from a side on perspective. Each of the compartments may extend above the sealing plane to a greater extent or to the same extent as each of the compartments extend below the sealing plane.

The first compartment may extend at least about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, about 26 mm, about 28 mm, or at least about 30 mm in the z-direction perpendicular to the sealing plane of the package.

The first compartment may extend no more than about 30 mm, about 28 mm, about 26 mm, about 24 mm, about 22 mm, about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, or no more than about 5 mm in the z-direction perpendicular to the sealing plane of the package.

The second compartment may extend at least about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, or at least about 26 mm in the z-direction perpendicular to the sealing plane of the package.

The second compartment may extend no more than about 26 mm, about 24 mm, about 22 mm, about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, or no more than about 4 mm in the z-direction perpendicular to the sealing plane of the package.

The third compartment may extend at least about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 16 mm, about 18 mm, or at least about 20 mm in the z-direction perpendicular to the sealing plane of the package.

The third compartment may extend no more than about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, or no more than about 2 mm in the z-direction perpendicular to the sealing plane of the package.

At least two of the first compartment, second compartment and third compartment may have different relative heights. The ‘height’ of each compartment is generally measured as the length that each compartment extends in the z-direction above the sealing plane.

The first compartment, second compartment and third compartment may each have different relative heights.

The first compartment may have a height greater than the height of the second compartment and greater than the height of the third compartment.

The second compartment may have a height less than the height of the first compartment and greater than the height of the third compartment.

The third compartment may have a height less than the height of the first compartment and less than the height of the second compartment.

The second compartment may have a height greater than half the height of the first compartment.

The third compartment may have a height greater than half the height of the second compartment.

The third compartment may have a height less than half the height of the first compartment.

The first compartment may have a height of at least about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, about 26 mm, about 28 mm, or at least about 30 mm.

The first compartment may have a height of no more than about 30 mm, about 28 mm, about 26 mm, about 24 mm, about 22 mm, about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, or no more than about 5 mm.

The second compartment may have a height of at least about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, or at least about 26 mm.

The second compartment may have a height of no more than about 26 mm, about 24 mm, about 22 mm, about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, or no more than about 4 mm.

The third compartment may have a height of at least about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 16 mm, about 18 mm, or at least about 20 mm.

The third compartment may have a height of no more than about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, or no more than about 2 mm.

The first compartment, second compartment and third compartment may provide a stepped height profile in at least one direction. For example, the first compartment may comprise the greatest height, the third compartment may comprise the smallest height, and the second compartment may comprise a height between that of the first compartment and the third compartment.

Advantageously, a stepped height profile provides for neat and space-saving stacking of adjacent multi-compartment packages in any suitable packaging unit, for example as may be required for e-commerce distribution.

Further advantageously, a stepped height profile allows adjacent packages to be stacked in a mechanically interlocked arrangement, such that the compartment having the greatest height of a first package is arranged opposite the compartment having the smallest height of a second package, and the compartment having the smallest height of the first package is arranged opposite the compartment having the greatest height of the second package.

Further advantageously, such packages are also significantly more likely to maintain their stacked arrangement throughout the distribution cycle, i.e. transport and storage, of the packages in a packaging unit. Advantageously, this provides for a more aesthetically pleasing arrangement of packages when delivered to the consumer, and this gives further indication of a high-quality product.

The shape of the multi-compartment package may be in the form of any suitable shape.

The shape of the multi-compartment package may be in the form of any shape capable of tessellation, for example any shape selected from the list comprising square, rectangle, hexagon, triangle, etc. It is meant that the shape of the multi-compartment package is defined by the periphery of the external sealing web when viewed in plan view.

Advantageously, a multi-compartment package according to the invention formed in a shape capable of tessellation significantly avoids wastage of the material from which the package is formed, for example water-soluble PVOH film sheets, during manufacture of the packages.

In embodiments of the invention comprising a substantially square-shaped or substantially rectangle-shaped multi-compartment package, the third compartment may be substantially located in a corner of the substantially square-shaped or substantially rectangle-shaped multi-compartment package.

Providing the third compartment substantially in a corner of the multi-compartment package partitions the third compartment from the second compartment by a minimal amount of the second internal sealing line. This means that there is a significantly reduced amount of inter-compartment contact between the third compartment and the second compartment. Advantageously, this significantly reduces the possibility of inter-compartment leakage of the third detergent composition into the second compartment and inter-compartment leakage of the second detergent composition into the third compartment.

The third compartment may be circular in shape. In embodiments where the third compartment is circular in shape and the third compartment is substantially located in a corner of a substantially square-shaped or substantially rectangle-shaped multi-compartment package, the second internal sealing line may form a quarter circle arc or sector shape.

The multi-compartment package may have one, two, three or more plane(s) of symmetry in a plane perpendicular to the sealing plane. In embodiments of the invention where the multi-compartment package is a square-based or rectangle-based multi-compartment package, the multi-compartment package may have one plane of symmetry which may extend from one corner of the package to an opposing corner of the package.

The first internal sealing line may extend across the multi-compartment package to connect the external sealing web of opposing or adjacent sides of the package.

The second internal sealing line may extend across the multi-compartment package to connect the external sealing web of opposing or adjacent sides of the package.

At least one or both of the first internal sealing line and the second internal sealing line may be a substantially continuously curved shape.

A multi-compartment package comprising at least one substantially continuously curved sealing line provides a reduced flexibility (increased rigidity) of the multi-compartment package, compared to a multi-compartment package comprising at least one straight, or substantially straight, internal sealing line.

It is known to provide a multi-compartment package comprising at least one straight, or substantially straight, i.e. at least 50-80% of the internal sealing line is a continuously straight, internal sealing line. Such packages exhibit a high degree of flexibility. This effect is more pronounced in multi-compartment packages comprising compartments arranged side-by-side and separated by at least one straight, or substantially straight, internal sealing line. Disadvantageously, multi-compartment packages which exhibit a high degree of flexibility provide an inferior handling experience of the package by the consumer and may indicate a low-quality or cheaply manufactured package. Further, multi-compartment packages which exhibit a high degree of flexibility are increasingly difficult to stack in a package stacking process, which may be required, for example, to stack a plurality of multi-compartment packages in an e-commerce-compatible packaging unit.

Advantageously, in embodiments of the invention where at least one or both of the first internal sealing line and the second internal sealing line are a substantially continuously curved shape, this provides a rigid multi-compartment package which, beneficially, provides a superior handling experience of the package by the consumer and indicates a high-quality package. Further advantageously, such packages provide for a relatively easy stacking process, for example in an e-commerce-compatible packaging unit. Such packages are also significantly more likely to maintain their stacked arrangement throughout the distribution cycle, i.e. transport and storage, of the packages in a packaging unit. Advantageously, this provides for a more aesthetically pleasing arrangement of packages when delivered to the consumer, and this gives further indication of a high-quality product.

A substantially curved first internal sealing line and/or substantially curved second internal sealing line may be in the form of a quarter circle arc or sector shape. Advantageously, an internal sealing line in the form of a quarter circle arc or sector shape provides the minimum length of sealing line required to separate adjacent compartments of a multi-compartment package, whilst maintaining a curved shape. As such, this provides a dual benefit of minimising the risk of inter-compartment leakage of any non-solid detergent compositions comprised in the multi-compartment package, for example the second detergent composition or the third detergent composition. This is because, typically, it is the internal sealing line(s) of a multi-compartment package which is prone to rupture (for example through the formation of microchannels between compartments) during transport or storage of the package, causing leakage of a detergent composition, so, by minimising the total area of the internal sealing, the risk of inter-compartment leakage is further reduced. Moreover, this provides a rigid multi-compartment package which, beneficially, provides a superior handling experience of the package by the consumer and indicates a high-quality package, and a relatively easy stacking process.

The first internal sealing line may be continuously curved along at least about 80%, about 85%, about 90%, about 95%, about 98%, or at least about 100% of its length.

The second internal sealing line may be continuously curved along at least about 80%, about 85%, about 90%, about 95%, about 98%, or at least about 100% of its length.

The multi-compartment package may be free of any substantially continuously straight internal sealing regions. By ‘substantially continuously straight’, it is meant an internal sealing region which is continuously straight along at least 80% of its length.

The first compartment may have a larger, or significantly larger, volume than that of either or both of the first and second compartments.

The second compartment may have a larger, or significantly larger, volume than that of the third compartment.

Volume is typically calculated based on the volume of the corresponding cavity in the mould used to make the multi-compartment package. Volume includes the solid or non-solid detergent composition plus any air or other gas that may be present, for example air or other gas arising from headspace from the cavity filling process.

According to a second aspect of the invention, there is provided a multi-compartment package for an automatic dishwashing cycle, the multi-compartment package comprising an external sealing web extending around a periphery of the multi-compartment package, and an internal sealing web which partitions the multi-compartment package to form a first compartment comprising a first detergent composition, a second compartment comprising a second detergent composition, and a third compartment comprising a third detergent composition, wherein the total area of the internal sealing web is less than 140 mm², and further wherein the total area of the external sealing web to the total area of the internal sealing web is in a ratio of between about 2.55:1 and about 3.55:1.

Advantageously, it has been found that a multi-compartment package according to the second aspect of the invention comprising a total area of the external sealing web and a total area of the internal sealing web present in a ratio of between about 2.55:1 and about 3.55:1 provides a significantly reduced risk of leakage of detergent compositions, in particular non-solid detergent compositions, comprised within the multi-compartment package, compared to a multi-compartment package comprising a total area of the external sealing web to a total area of the internal sealing web present in a ratio of less than 2.55:1.

The invention according to the second aspect may optionally include any of the features of the invention according to the first aspect.

According to a third aspect of the invention, there is provided a packaging unit comprising a plurality of multi-compartment packages according to the first aspect of the invention or the second aspect of the invention.

The plurality of multi-compartment packages may comprise a first multi-compartment package according to the first aspect or second aspect and a second multi-compartment package according to the first aspect or second aspect, wherein the first compartment of each package has a first height, the second compartment of each package has a second height less than the first height, and the third compartment of each package has a third height less than the first and second heights.

Such an arrangement of compartments provides for a stepped height profile of compartments in at least one direction.

Advantageously, a stepped height profile provides for neat and space-saving stacking of adjacent multi-compartment packages in the packaging unit, for example as may be required for e-commerce distribution.

Further advantageously, a stepped height profile of the form described above allows adjacent multi-compartment packages to be stacked in a mechanically interlocked arrangement. Such packages are significantly more likely to maintain their stacked arrangement throughout the distribution cycle, i.e. transport and storage, of the packages in the packaging unit. Advantageously, this provides for a more aesthetically pleasing arrangement of packages when delivered to the consumer, and this provides an indication of a high-quality product.

The first multi-compartment package and the second multi-compartment package may be arranged to overlap one another by superposition of the first compartment of the first multi-compartment package with the third compartment of the second multi-compartment package, and superposition of the third compartment of the first multi-compartment package with the first compartment of the second multi-compartment package.

The plurality of multi-compartment packages may form at least one bilayer arrangement of multi-compartment packages within the packaging unit. The at least one bi-layer may be formed of a first layer of individual multi-compartment packages with a second layer of individual multi-compartment packages superposed thereon.

The packaging unit may comprise multiple bi-layers of multi-compartment packages.

Advantageously, such an arrangement is neat and provides for an aesthetically pleasing array of packages.

The packaging unit may be selected from the group comprising a plastic (for example, HDPE or PET) tub, plastic bag, plastic tray, paperboard tray, for example made of corrugated cardboard. The plastic bag may be a flexible plastic bag or a rigid plastic bag.

The invention according to the third aspect may optionally include any of the features of the invention according to the first aspect or the second aspect.

According to a fourth aspect of the invention, there is provided a use of a multi-compartment package according to the first aspect or the second aspect, for treating or washing soiled kitchenware.

The kitchenware may comprise tableware, such as, for example, crockery, cutlery, and the like.

The kitchenware may comprise elements made of glass, such as, for example, glass vessels, beakers, containers, jars, and the like.

The invention according to the fourth aspect may optionally include any of the features of the invention according to the first aspect, the second aspect or the third aspect.

According to a fifth aspect of the invention, there is provided a multi-compartment package for an automatic dishwashing cycle, the multi-compartment package comprising an external sealing web extending around a periphery of the package, and an internal sealing web which partitions the package to form a first compartment comprising a first detergent composition in the form of a solid, a second compartment comprising a second detergent composition, and a third compartment comprising a third detergent composition, wherein the internal sealing web comprises at least a first internal sealing region arranged across the package to partition the first compartment and the second compartment, and a second internal sealing region arranged across the package to partition the second compartment and the third compartment, wherein the first compartment is separated from the third compartment by the first internal sealing region, the second compartment and the second internal sealing region, further wherein the first internal sealing region and the second internal sealing region are a substantially continuously curved shape.

In some embodiments, the first internal sealing region is a first internal sealing line.

In some embodiments, the second internal sealing region is a second internal sealing line.

Advantageously, providing the first internal sealing line and the second internal sealing line in a substantially continuously curved shape provides a reduced flexibility (increased rigidity) of the multi-compartment package, compared to a multi-compartment package comprising at least one straight, or substantially straight, internal sealing line.

It is known to provide a multi-compartment package comprising at least one straight, or substantially straight, i.e. at least 80% of the internal sealing line is continuously straight, internal sealing line. Such packages exhibit a high degree of flexibility. This effect is more pronounced in multi-compartment packages comprising compartments arranged side-by-side and separated by a straight, or substantially straight, internal sealing line. Disadvantageously, multi-compartment packages which exhibit a high degree of flexibility provide an inferior handling experience of the package by the consumer and may indicate a low-quality or cheaply manufactured package. Further, multi-compartment packages which exhibit a high degree of flexibility are increasingly difficult to stack in a package stacking process, which may be required, for example, to stack a plurality of multi-compartment packages in an e-commerce-compatible packaging unit.

Advantageously, providing the first internal sealing line and the second internal sealing line in a substantially continuously curved shape provides a rigid multi-compartment package which, beneficially, provides a superior handling experience of the package by the consumer and indicates a high-quality package. Further advantageously, such packages provide for a relatively easy stacking process, for example in an e-commerce-compatible packaging unit. Such packages are also significantly more likely to maintain their stacked arrangement throughout the distribution cycle, i.e. transport and storage, of the packages in a packaging unit. Advantageously, this provides for a more aesthetically pleasing arrangement of packages when delivered to the consumer, and this gives further indication of a high-quality product.

By ‘substantially continuously curved’, it is meant an internal sealing line which is curved along at least about 80% of its length.

The first internal sealing line may be continuously curved along at least about 80%, about 85%, about 90%, about 95%, about 98%, or at least about 100% of its length.

The second internal sealing line may be continuously curved along at least about 80%, about 85%, about 90%, about 95%, about 98%, or at least about 100% of its length.

The multi-compartment package may be free of any substantially continuously straight internal sealing regions. By ‘substantially continuously straight’, it is meant an internal sealing region which is continuously straight along at least 80% of its length.

At least two of the first compartment, second compartment and third compartment may have a different height.

The first compartment, second compartment and third compartment may provide a stepped height profile in at least one direction.

The first compartment may have a height greater than the height of the second compartment, and the second compartment has a height greater than the height of the third compartment.

Advantageously, a stepped height profile provides for neat and space-saving stacking of adjacent multi-compartment packages in any suitable packaging unit, for example as may be required for e-commerce distribution.

Further advantageously, a stepped height profile allows adjacent packages to be stacked in a mechanically interlocked arrangement, such that the first compartment having the greatest height of a first package is arranged opposite a third compartment having the smallest height of a second package, and the third compartment having the smallest height of the first package is arranged opposite the first compartment having the greatest height of the second package.

Further advantageously, such packages are significantly more likely to maintain their stacked arrangement throughout the distribution cycle, i.e. transport and storage, of the packages in a packaging unit. Advantageously, this provides for a more aesthetically pleasing arrangement of packages when delivered to the consumer, and this gives further indication of a high-quality product.

The external sealing web may lie in a sealing plane (x-y plane) such that each of the compartments of the multi-compartment package extend above and/or below (z-direction) the sealing plane when viewed from a side on perspective. Each of the compartments may extend above the sealing plane to a greater extent or to the same extent as each of the compartments extend below the sealing plane.

The ‘height’ of each compartment is generally measured as the length that each compartment extends in the z-direction above the sealing plane.

The first compartment may have a height of at least about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, about 26 mm, about 28 mm, or at least about 30 mm.

The first compartment may have a height of no more than about 30 mm, about 28 mm, about 26 mm, about 24 mm, about 22 mm, about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, or no more than about 5 mm.

The second compartment may have a height of at least about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, or at least about 26 mm.

The second compartment may have a height of no more than about 26 mm, about 24 mm, about 22 mm, about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, or no more than about 4 mm.

The third compartment may have a height of at least about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 16 mm, about 18 mm, or at least about 20 mm.

The third compartment may have a height of no more than about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, or no more than about 2 mm.

The external sealing web may comprise a width of at least about 1 mm, about 1.2 mm, about 1.4 mm, about 1.6 mm, about 1.8 mm, about 2.0 mm, about 2.2 mm, about 2.4 mm, about 2.6 mm, about 2.8 mm, or at least about 3.0 mm.

The external sealing web may comprise a width of no more than about 3.0 mm, about 2.8 mm, about 2.6 mm, about 2.4 mm, about 2.2 mm, about 2.0 mm, about 1.8 mm, about 1.6 mm, about 1.4 mm, about 1.2 mm, or no more than about 1.0 mm.

The external sealing web may have a width of between about 1.0 mm and about 3.0 mm, between about 1.2 mm and about 2.8 mm, between about 1.4 mm and about 2.6 mm, between about 1.6 mm and about 2.4 mm, between about 1.8 mm and about 2.2 mm, or about 2.0 mm.

The internal sealing web may have a width of between about 0.8 mm and about 3.0 mm, between about 1.0 mm and about 2.8 mm, between about 1.2 mm and about 2.6 mm, between about 1.3 mm and about 2.4 mm, between about 1.4 mm and about 2.3 mm, between about 1.5 mm and about 2.2 mm, between about 1.6 and about 2.0 mm, between about 1.7 mm and about 1.9 mm, or about 1.8 mm.

The internal sealing web may comprise a width of at least about 1 mm, about 1.2 mm, about 1.4 mm, about 1.6 mm, about 1.8 mm, about 2.0 mm, about 2.2 mm, about 2.4 mm, about 2.6 mm, about 2.8 mm, or at least about 3.0 mm.

The internal sealing web may comprise a width of no more than about 3.0 mm, about 2.8 mm, about 2.6 mm, about 2.4 mm, about 2.2 mm, about 2.0 mm, about 1.8 mm, about 1.6 mm, about 1.4 mm, about 1.2 mm, or no more than about 1.0 mm.

The invention according to the fifth aspect may optionally include any of the features of the invention according to any former aspect of the invention.

According to a sixth aspect of the invention, there is provided a multi-compartment package for an automatic dishwashing cycle, the multi-compartment package comprising an external sealing web extending around a periphery of the package, and an internal sealing web which partitions the package to form a first compartment comprising a first detergent composition, a second compartment comprising a second detergent composition, and a third compartment comprising a third detergent composition, wherein the internal sealing web comprises at least a first internal sealing region arranged across the package to partition the first compartment and the second compartment, and a second internal sealing region arranged across the package to partition the second compartment and the third compartment, wherein the first compartment is separated from the third compartment by the first internal sealing region, the second compartment and the second internal sealing region, further wherein the first compartment has a height greater than the height of the second compartment, and the second compartment has a height greater than the height of the third compartment.

In some embodiments, the first internal sealing region is a first internal sealing line.

In some embodiments, the second internal sealing region is a second internal sealing line.

A multi-compartment package comprising a first compartment having a height greater than the height of a second compartment, and the second compartment having a height greater than the height of a third compartment provides for a stepped height profile arrangement of the compartments. Advantageously, a stepped height profile provides for neat and space-saving stacking of adjacent multi-compartment packages in any suitable packaging unit, for example as may be required for e-commerce distribution.

Further advantageously, a stepped height profile allows adjacent packages to be stacked in a mechanically interlocked arrangement, such that the compartment having the greatest height of a first package is arranged opposite the compartment having the smallest height of a second package, and the compartment having the smallest height of the first package is arranged opposite the compartment having the greatest height of the second package.

Further advantageously, such packages are also significantly more likely to maintain their stacked arrangement throughout the distribution cycle, i.e. transport and storage, of the packages in a packaging unit. Advantageously, this provides for a more aesthetically pleasing arrangement of packages when delivered to the consumer, and this gives further indication of a high-quality product.

The external sealing web may lie in a sealing plane (x-y plane) such that each of the compartments of the multi-compartment package extend above and/or below (z-direction) the sealing plane when viewed from a side on perspective. Each of the compartments may extend above the sealing plane to a greater extent or to the same extent as each of the compartments extend below the sealing plane.

The ‘height’ of each compartment is generally measured as the length that each compartment extends in the z-direction above the sealing plane.

The first compartment may have a height of at least about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, about 26 mm, about 28 mm, or at least about 30 mm.

The first compartment may have a height of no more than about 30 mm, about 28 mm, about 26 mm, about 24 mm, about 22 mm, about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, or no more than about 5 mm.

The second compartment may have a height of at least about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 22 mm, about 24 mm, or at least about 26 mm.

The second compartment may have a height of no more than about 26 mm, about 24 mm, about 22 mm, about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, or no more than about 4 mm.

The third compartment may have a height of at least about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 16 mm, about 18 mm, or at least about 20 mm.

The third compartment may have a height of no more than about 20 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, or no more than about 2 mm.

The invention according to the sixth aspect may optionally include any of the features of the invention according to any former aspect

One or more of the following cleaning active categories may be present in the first detergent composition, second detergent composition or third detergent composition, or in any detergent composition located in any compartment of a multi-compartment package of the invention, as desired. More than one ingredient from each cleaning active category may be present, if a cleaning active category is present in the multi-compartment package of the invention.

### CLEANING ACTIVES

If the inventive composition may be used as part of a dishwashing detergent, it can be used in combination with their state of the art ingredients. Those skilled in the art will appreciate that where the term “detergent” is used herein, this does also include rinse aid and any other additive composition used to be applied during dishwashing in a dishwasher. The multi-compartment package may comprise at least one active component which may be selected from the group comprising surfactants, alkalinity sources, acidity sources (especially for rinse aid and machine cleaner), builders, enzymes, polymers, anti-corrosion agents, bleach, care agents and other auxiliary ingredients like fragrance, dye, etc.

### Builder

The multi-compartment package may comprise any ingredients known in the art. The multi-compartment package may comprise a builder. The builder may be either a phosphate-containing builder or a phosphate-free builder, or a mixture of each, as desired. In many countries, including the United States and in the European Union, phosphate builders are restricted and so phosphate-free builders are preferred. The multi-compartment package may comprise a secondary builder (co-builder).

The phosphate-free builder may also or alternatively comprise non- polymeric organic molecules with one or more carboxylic group(s). Builder compounds which are organic molecules comprising carboxylic groups may include at least one selected from the group comprising citric acid, fumaric acid, tartaric acid, maleic acid, lactic acid and salts thereof. The alkali or alkaline earth metal salts of these organic compounds may be used, in particular, but not limited to, the sodium salts. The phosphate-free builder may be at least one selected from the group comprising sodium citrate, citrate trisodium, trisodium citrate dihydrate, or mixtures thereof.

The phosphate-free co-builder may be at least one polycarboxylate(s) which comprise two carboxyl groups selected from the group comprising water-soluble salts of malonic acid, (ethylenedioxy)diacetic acid, maleic acid, diglycolic acid, tartaric acid, tartronic acid and fumaric acid. The phosphate-free co-builder may be at least one polycarboxylate(s) which comprise three carboxyl groups, for example, water-soluble citrate. The phosphate-free co-builder may be at least one hydroxycarboxylic acid, for example, citric acid.

If phosphate-containing builders are to be used, the phosphate-containing builder may be at least one phosphate-containing builder selected from the group comprising monophosphates, di-phosphates, tri-polyphosphates or oligomeric-poylphosphates, or its alkali metal salt, in particular, but not limited to, its sodium salt, for example sodium tripolyphosphate (STPP).

Conventional amounts of the phosphate-containing builders may be used, typically in the range of from about 15% by weight to about 70% by weight, or from about 20% by weight to about 60% by weight, or from about 25% by weight to about 50% by weight. If additional phosphate-free builder is included, the phosphate-free builder may be chosen from succinate based compounds. It is intended that the term ‘succinate based compound’ includes succinic acid based compounds, and such terms may be used interchangeably herein. Conventional amounts of the succinate based compounds may be used, typically in the range of from about 5% by weight to about 80% by weight, or from about 15% by weight to about 70% by weight, or from about 20% by weight to about 60% by weight. The compounds may be used individually or as a mixture.

The multi-compartment package may include at least one suitable builder selected from the list comprising glutamic acid N,N-diacetic acid (GLDA), methylglycinediacetic acid (MGDA). aspartic acid- N-monoacetic acid (ASMA), aspartic acid-N,N-diacetic acid (ASDA), aspartic acid-N- monopropionic acid (ASMP), iminodisuccinic acid (IDA), N-(2- sulfomethyl) aspartic acid (SMAS), N- (2-sulfoethyl)aspartic acid (SEAS), N- (2- sulfomethyl)glutamic acid (SMGL), N-(2-sulfoethyl)glutamic acid (SEGL), N- methyliminodiacetic acid (MIDA), a- alanine-N,N-diacetic acid (a-ALDA), β- alanine-N,N-diacetic acid (β-ALDA), serine-N,N-diacetic acid (SEDA), isoserine- N,N-diacetic acid (ISDA), phenylalanine-N,N-diacetic acid (PHDA), anthranilic acid-N, N- diacetic acid (ANDA), sulfanilic acid-N, N-diacetic acid (SLDA), taurine- N, N-diacetic acid (TUDA) and sulfomethyl-N, N-diacetic acid (SMDA), tetrasodium imminosuccinate, iminodisuccinic acid (IDS) and (hydroxy)iminodisuccinic acid (HIDS) and alkali metal salts or ammonium salts thereof, or mixtures thereof.

The builder may comprise at least one homopolymer or copolymer selected from the group comprising homopolymers and copolymers of polycarboxylic acids and their partially or completely neutralised salts, monomeric polycarboxylic acids and hydroxycarboxylic acids and their salts, phosphates and phosphonates, and mixtures thereof. The salts of the abovementioned compounds may be selected from the group comprising the ammonium and/or alkali metal salts, i.e. the lithium, sodium, or potassium salt.

The builder may be an organic builder.

The total amount of builder present in the multi-compartment package may be at least about 5% by weight, at least about 10% by weight, at least about 15% by weight, at least about 20% by weight, at least about 25% by weight, at least about 30% by weight, at least about 35% by weight, at least about 40% by weight, at least about 45% by weight, or at least about 50% by weight.

The total amount of builder present in the multi-compartment package may be in an amount of up to about 80% by weight, up to about 70% by weight, up to about 60% by weight, up to about 50% by weight, or up to about 45% by weight. The actual amount used in the detergent composition may depend upon the nature of the builder used.

### Surfactant

The multi-compartment package may include at least one surfactant. The at least one surfactant may be selected from the group comprising non-ionic, anionic, cationic, amphoteric or zwitterionic surface active agents, or suitable mixtures thereof. The non-ionic surfactant may be an ethoxylated non-ionic surfactant prepared by the reaction of a monohydroxy alkanol with about 6 to about 20 carbon atoms. The surfactant may have at least about 12 moles, at least about 16 moles, at least about 20 moles, or at least about 25 moles, of ethylene oxide per mole of alcohol. The non-ionic surfactant may be from a linear chain fatty alcohol with about 16 to about 20 carbon atoms and at least about 12 moles, at least about 16 moles, or at least about 20 moles of ethylene oxide per mole of alcohol.

The non-ionic surfactant may additionally comprise propylene oxide units in the surfactant molecule. The propylene oxide units may constitute up to about 25% by weight, up to about 20 % by weight, or up to about 15% by weight of the overall molecular weight of the non-ionic surfactant.

The surfactant may be an ethoxylated mono-hydroxy alkanols which additionally comprise polyoxyethylene-polyoxypropylene block copolymer units. The alcohol portion of the ethoxylated mono-hydroxy alkanols may constitute more than about 30% by weight, more than about 50% by weight, or more than about 70% by weight of the overall molecular weight of the non-ionic surfactant. The non-ionic surfactant may comprise reverse block copolymers of polyoxyethylene and polyoxypropylene and block copolymers of polyoxyethylene and polyoxypropylene initiated with trimethylolpropane.

The non-ionic surfactant may be a surfactant described by the formula:

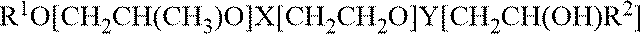

where R¹ represents a linear or branched chain aliphatic hydrocarbon group with about 4 to about 18 carbon atoms or a mixture thereof, R² represents a linear or branched chain aliphatic hydrocarbon rest with about 2 to about 26 carbon atoms or a mixture thereof, x is a value between about 0.5 and about 1.5, and y is a value of at least about 15.

The non-ionic surfactant may be an end-capped polyoxyalkylated non-ionic surfactant of the formula:

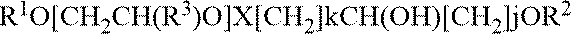

where R¹ and R² represent linear or branched chain, saturated or unsaturated, aliphatic or aromatic hydrocarbon groups with about 1 to about 30 carbon atoms, R³ represents a group selected from the group comprising a hydrogen atom or a methyl, ethyl, n-propyl, iso-propyl, n-butyl, 2-butyl or 2- methyl-2-butyl group, x is a value between about 1 and about 30, between about 1 and about 20, or between about 6 and about 15, and, k and j are values between about 1 and about 12, between about 1 and about 5, or k may be about 1 and j may be about 1. When the value of x is greater than about 2, each R³ in the formula above may be different. R¹ and R² may be linear or branched chains, saturated or unsaturated, aliphatic or aromatic hydrocarbon groups with about 6 to about 22 carbon atoms, or about 8 to about 18 carbon atoms.

As described above, where the value of x is greater than about 2, each R³ in the formula can be different. For example, when x=3, R³ may be ethylene oxide (EO) (R³ = H) or propylene oxide (PO) (R³ = methyl) units which can be used in any order, for example an order selected from the group comprising (PO)(EO)(EO), (EO)(PO)(EO), (EO)(EO)(PO), (EO)(EO)(EO), (PO)(EO)(PO), (PO)(PO)(EO) and (PO)(PO)(PO).

The multi-compartment package may comprise a non-ionic surfactant comprising a mixture of alkoxylated alcohols and hydroxy-group containing alkoxylated alcohols.

The multi-compartment package may comprise a non-ionic surfactant in an amount of from about 0.1% by weight to about 20% by weight, about 1% by weight to about 15% by weight, or about 2% to about 10% by weight, based on the total weight of the detergent composition in which it is comprised.

### Enzyme

The multi-compartment package may comprise at least one enzyme. The at least one enzyme may be selected from the group comprising protease, lipase, amylase, cellulase and peroxidase, or mixtures thereof. Advantageously, enzymes, in particular, but not limited to, protease and amylase, provide favourable cleaning efficacy in dishwashing detergent compositions. Any suitable species of these enzymes may be used as desired. More than one species may be used.

The multi-compartment package may comprise at least about 0.001 mg, at least about 0.01 mg, or at least about 0.1 mg of active enzyme per gram of package.

The multi-compartment package may comprise from about 1.5 to about 10 mg, from about 1.8 to about 5 mg, or from about 2 to about 4 mg of active enzyme per gram of package.

### Bleach

The multi-compartment package may comprise at least one bleach additive or bleach activation catalyst. The at least one bleach additive or bleach activation catalyst may be selected from the group comprising an organic peracid, for example perbenzoic acid and peroxycarboxylic acids e.g. phthalimido peroxy caproic acid (PAP). Advantageously, organic peracids do not require the use of a bleach activator or catalyst as these bleaches are active at relatively low temperatures, for example at about 30° C. and this contributes to such bleach materials being preferred according to the present invention.

The multi-compartment package may comprise one or more bleach activator or bleach catalyst, dependent on the nature of the bleaching compound. The bleach activator may be Tetraacetylethylenediamine (TAED). The bleach catalyst may be selected from the group comprising manganese oxalate, manganese acetate or a dinuclear manganese complex.

The multi-compartment package may comprise water.

### Acidity and Alkalinity

The multi-compartment package may comprise a source of acidity or a source of alkalinity, to obtain the desired pH on dissolution. A source of acidity may be any acidic compound, for example a polycarboxylic acid, for example citric acid. A source of alkalinity may be selected from the group comprising a carbonate or bicarbonate (such as an alkali metal or alkaline earth metal salt). A source of alkalinity may be any basic compound, for example any salt of a strong base and a weak acid. An alkalinity source may be selected from the group comprising an alkali hydroxide, alkali hydride, alkali oxide, alkali sesquicarbonate, alkali carbonate, alkali borate, alkali salt of mineral acid, alkali amine, alkaloid, or mixtures thereof. The alkalinity source may be selected from the group comprising sodium carbonate, sodium hydroxide or potassium hydroxide. The source of alkalinity may be present in an amount sufficient to give the wash liquor a pH of from about 8 to about 12, preferably from about 9 to about 11.5. The package may comprise from about 1% to about 40%, or from about 2% to about 20% by weight of the composition, of a source of alkalinity.

The source of alkalinity may comprise a source of univalent ions. Beneficially, univalent ions contribute to high alkalinity and, advantageously, only minimally raise the ionic strength of the wash solution. The alkalinity source may be a metal hydroxide, for example, selected from the group comprising sodium hydroxide or potassium hydroxide.

### Anti-Corrosion Agent

The multi-compartment package may comprise one or more anti-corrosion agent(s). Anti-corrosion agents may provide benefits against corrosion of glass and/or metal and the term encompasses agents that are intended to prevent or reduce the tarnishing of non-ferrous metals, in particular of silver and copper.

The multi-compartment package may comprise at least one multivalent ion. The at least one multivalent ion may be selected from the group comprising zinc, bismuth and/or manganese ions. Beneficially, these multivalent ions may inhibit corrosion of glass and/or metal.

The multi-compartment package may comprise polymers for inhibit corrosion of glass and/or metal like polyalkylenimmines and/or polyquats.

The multi-compartment package may comprise organic and inorganic redox-active substances which are known as suitable for use as silver/copper corrosion inhibitors. The inorganic redox-active substances may be at least one metal salt and/or metal complex selected from the group comprising zinc, bismuth, manganese, titanium, zirconium, hafnium, vanadium, cobalt and cerium salts and/or complexes thereof, the metals being in one of the oxidation states II, III, IV, V or VI. The at least one metal salt and/or metal complex may be selected from the group comprising of MnSO₄, Mn(ll) citrate, Mn(ll) stearate, Mn(ll) acetylacetonate, Mn(ll) [1-hydroxyethane-1 , 1-diphosphonate], V₂O₅, V₂O, VO₂, TiOSO₄, K₂TiF₆, K₂ZrF₆, CoSO₄, Co(NO₃)₂, zinc acetate, zinc sulphate and Ce(NO₃)₂. The source of multivalent ions may be selected from the group comprising sulphates, carbonates, acetates, gluconates and metal-protein compounds.

The multi-compartment package may comprise at least one silver/copper anti-corrosion agent. The at least one silver/copper anti-corrosion agent may be selected from the group comprising benzotriazole (BTA) or bis-benzotriazole, or substituted derivatives thereof, for example tolyltriazole. Benzotriazole derivatives are those compounds in which the available substitution sites on the aromatic ring are partially or completely substituted, for example linear or branch-chain C₁₋₂₀ alkyl groups and hydroxyl, thio, phenyl or halogen such as fluorine, chlorine, bromine and iodine.

The multi-compartment package may comprise an anti-corrosion agent in an amount of from about 0.01% by weight to about 5% by weight, about 0.05% by weight to about 3% by weight, about 0.1% by weight to about 2.5% by weight, or about 0.2% by weight to about 2% by weight, based on the total weight.

### Polymer

The multi-compartment package may comprise one or more polymer(s). Beneficially, one or more polymer(s) may improve the cleaning performance of the detergent composition. The polymer may be a sulphonated polymer. The polymer may be a copolymer. The copolymer may be a copolymer of

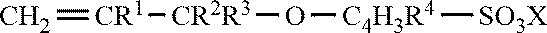

where R¹, R², R³ and R⁴ are independently about 1 to about 6 carbon alkyl or hydrogen, and X is hydrogen or alkali with any suitable other monomer units selected from the group comprising modified acrylic, fumaric, maleic, itaconic, aconitic, mesaconic, citraconic and methylenemalonic acid or their salts, maleic anhydride, acrylamide, alkylene, vinylmethyl ether, styrene, or mixtures thereof.

The (co)polymer may include sulphonated monomer units. The sulphonated monomer units may be selected from the group comprising 2- acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof, or mixtures thereof.

The multi-compartment package may comprise a sulphonated polymer in an amount of at least about 0.1% by weight, at least about 0.5% by weight, at least about 1% by weight, at least about 3% by weight, or up to about 40% by weight, up to about 25% by weight, up to about 15 % by weight, or up to about 10% by weight.

### Foam Control Agent

The multi-compartment package may comprise one or more foam control agent(s). The one or more foam control agent(s) may be any conventionally used in this field, for example selected from the group comprising silicones and their derivatives, or paraffin oil, or mixtures thereof. The foam control agent may be present in an amount of about 0.5% by weight or less.

### Preservative

The multi-compartment detergent composition may comprise minor, conventional, amounts of one or more preservative(s).

### Auxiliary

The multi-compartment package may comprise auxiliary ingredients like e.g. fragrance, dye.

### DETAILED DESCRIPTION OF THE INVENTION

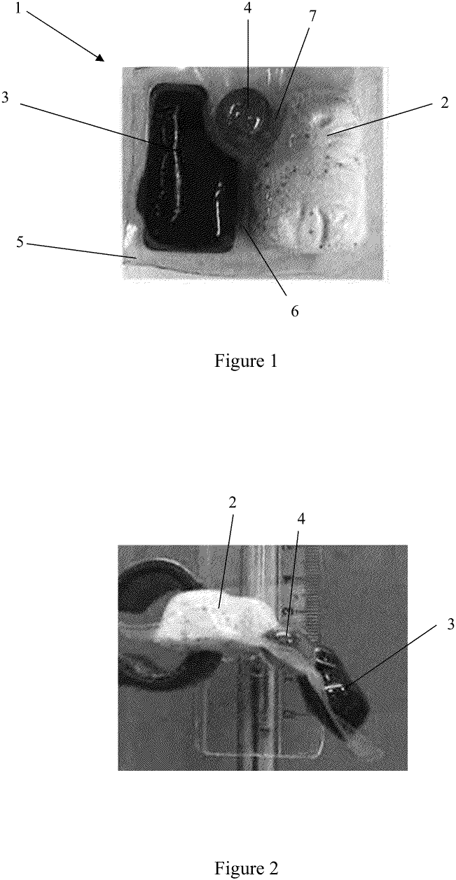

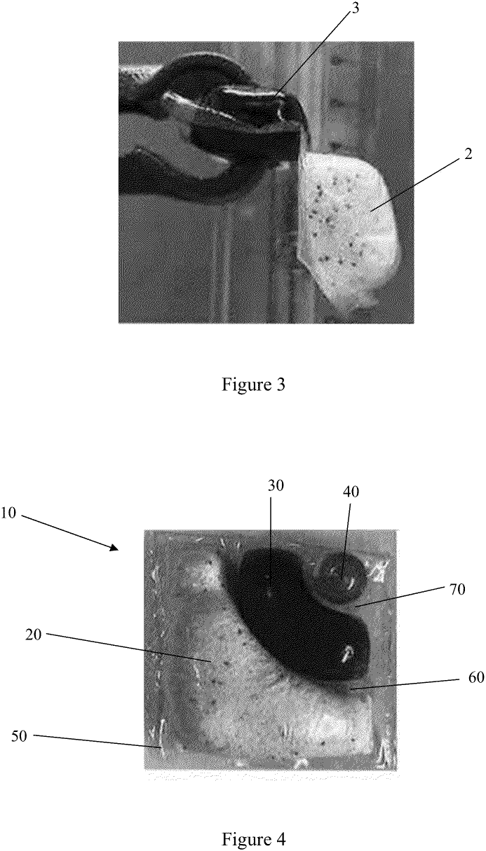

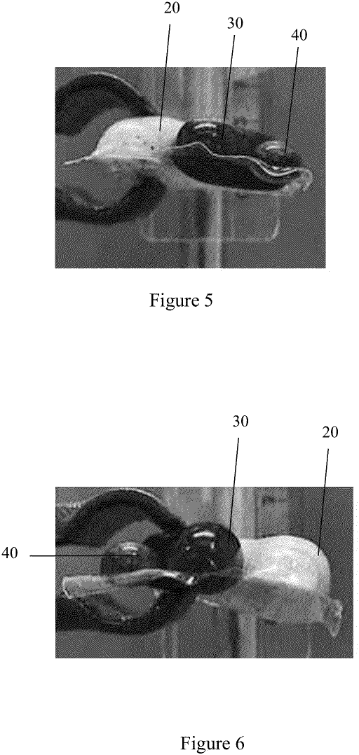

In order that the invention may be more clearly understood one or more embodiments thereof will now be described, by way of example only, with reference to the accompanying drawings, of which:
FIG. 1 shows a multi-compartment package as an example of the prior art;
FIG. 2 shows a side-on view of the multi-compartment package of FIG. 1;
FIG. 3 shows an alternative side-on view of the multi-compartment package of FIG. 1;
FIG. 4 shows a multi-compartment package according to an embodiment of the invention;
FIG. 5 shows a side-on view of the multi-compartment package of FIG. 4;
FIG. 6 shows an alternative side-on view of the multi-compartment package of FIG. 4.

### EXAMPLES

### Example 1 - Leakage Performance

With reference to the figures, two compositions, Comparative Formulation (1) (see FIG. 1) and Inventive Formulation (1) (see FIG. 4), were prepared. Each Formulation comprised a multi-compartment package 1, 10 comprising an external sealing web 5, 50 extending around a periphery of the package 1, 10, and an internal sealing web which partitions the package to form a first compartment 2, 20 comprising a first detergent composition in the form of a compressed powdered solid, a second compartment 3, 30 comprising a second detergent composition in the form of a gel, and a third compartment 4, 40 comprising a third detergent composition in the form of a liquid having a viscosity lower than the viscosity of the gel of the second detergent composition.

### Inventive Formulation (1)

The internal sealing web of Inventive Formulation (1) 10 comprised a first internal sealing region, in the form of a first internal sealing line 60, arranged across the package to partition the first compartment 20 and the second compartment 30, and a second internal sealing region, in the form of a second internal sealing line 70, arranged across the package to partition the second compartment 30 and the third compartment 40. The first detergent composition was separated from the third detergent composition by the first internal sealing line 60, the second compartment 30 and the second internal sealing line 70.

The first and second internal sealing lines 60, 70 extended across the multi-compartment package 10 to connect the external sealing web 50 of adjacent sides of the package. The first and second internal sealing lines 60, 70 had a substantially continuous curved shape.

The relative heights (as described below) of the compartments 20, 30, 40 provided a stepped height profile in one direction across the package.

The multi-compartment package 10 had a substantially square shape, and the third compartment 40 was located in a corner of the substantially square shaped multi-compartment package 10. The multi-compartment package 10 comprised a single plane of symmetry.

### Comparative Formulation (1)

The internal sealing web of Comparative Formulation (1) comprised a first internal sealing region, in the form of a first internal sealing line 6, arranged partially across the package to partition the first compartment 2 and the second compartment 3. The first internal sealing line 6 was continuously straight. The first internal sealing line 6 connected the external sealing web 5 at one side of the package to a second internal sealing region, in the form of a second internal sealing line 7, at a substantially central point relative to the confines of the package 1 when viewed in plan view. The second internal sealing line 7 was arranged across the package 1 to partition the third compartment 4 and the first 2 and second compartments 3. In Comparative Formulation (1), the first compartment 2 was directly adjacent to the second compartment 3 and the third compartment 4. The second internal sealing line 7 was continuously curved and extended from the external sealing web 5 at one side of the package 1 to the external sealing web 5 at the same side of the package 1.

The multi-compartment package 1 had a substantially rectangle shape, and the third compartment 4 was located in relative proximity to the external sealing web 5 at one side of the multi-compartment package 1, in a substantially mid-point between two corners of the substantially rectangle shaped multi-compartment package 1.

The dimensions of each of Comparative Formulation (1) and Inventive Formulation (1) are provided below.

| Dimension | Comparative Formulation (1) | Inventive Formulation (1) |
|---|---|---|
| Width of first internal sealing line (mm) | 2.0 | 1.8 |
| Width of second internal sealing line (mm) | 2.0 | 1.8 |
| Width of external sealing web (mm) | 2.0 | 2.0 |
| Height of first compartment (mm) | 13.0 | 15.2 |
| Height of second compartment (mm) | 10.9 | 12.0 |
| Height of third compartment (mm) | 7.4 | 7.5 |
| Total sealing area of internal sealing web (mm2) | 141 | 115 |
| Total sealing area of external sealing web (mm2) | 356 | 336 |
| Ratio of total sealing area of external sealing web to total sealing area of internal sealing web | 2.52 | 2.92 |

Notably, due to the arrangement of the compartments of Inventive Formulation (1), there is a significantly reduced risk of inter-compartment leakage of the liquid detergent composition into the first compartment comprising the solid detergent composition.

As such, the risk of detrimentally affecting the package aesthetic and functionality of the solid detergent composition is significantly reduced, while maintaining the benefits of a three-compartment detergent package.

Further, providing a compartment comprising a solid detergent composition separated from a compartment comprising a liquid detergent composition by a first and a second internal sealing line and a second compartment, further significantly reduces the possibility of leakage of the liquid detergent composition into the compartment comprising the solid detergent composition. Inventive Formulation (1) provides a multi-compartment package comprising a compartment comprising a solid detergent composition not arranged directly adjacent to the compartment comprising a liquid detergent composition having the lowest viscosity of the detergent compositions comprised in the package. Thus, the risk of inter-compartment leakage of the at least one non-solid detergent composition having the lowest viscosity is significantly reduced. As such, the risk of detrimentally affecting the package aesthetic and functionality of the solid detergent composition is significantly reduced, while maintaining the benefits of a three-compartment detergent package.

### Example 2 - Handling Performance

With reference to FIGS. 2, 3, 5 and 6, each of the Comparative Formulation (1) and the Inventive Formulation (1) was clamped at its first compartment (FIGS. 2 and 5) and separately at its second compartment (FIGS. 3 and 6).

Notably, Inventive Formulation (1), comprising curved internal sealings lines 60, 70 only, providing a far more rigid (i.e. less flexible) multi-compartment package 10 compared to the multi-compartment package 1 of the Comparative Formulation (1).

In each trial, Inventive Formulation (1) provided a more rigid handling performance than Comparative Formulation (1) which, advantageously, provides a superior handling experience of the package by the consumer and indicates a high-quality package.

Moreover, the rigidity of Inventive Formulation (1) provides for a relatively easy stacking process, for example as a bi-layer of packages in an e-commerce-compatible packaging unit. Such packages are also significantly more likely to maintain their stacked arrangement throughout the distribution cycle, i.e. transport and storage, of the packages in a packaging unit. Advantageously, this provides for a more aesthetically pleasing arrangement of packages when delivered to the consumer, and this gives further indication of a high-quality product.

### Example 3 - Stackability Performance

As described above, Inventive Formulation (1) provides a well-defined stepped height profile in one direction across the package.

Notably, the stepped height profile of Inventive Formulation (1) allows adjacent multi-compartment packages of Inventive Formulation (1) to be stacked in a mechanically interlocked arrangement, such that the first compartment having the greatest height of a first package is arranged opposite the third compartment having the smallest height of a second package, and the third compartment having the smallest height of the first package is arranged opposite the first compartment having the greatest height of the second package.

The interlocked arrangement allows packages of Inventive Formulation (1) to maintain their stacked arrangement throughout the distribution cycle, i.e. transport and storage, of the packages in a packaging unit. As such, this provides for a more aesthetically pleasing arrangement of packages when delivered to the consumer, and this gives further indication of a high-quality product.

The one or more embodiments are described above by way of example only. Many variations are possible without departing from the scope of protection afforded by the appended claims.

1. A multi-compartment package for an automatic dishwashing cycle, the multi-compartment package comprising:
an external sealing web extending around a periphery of the package, and
an internal sealing web which partitions the package to form a first compartment comprising a first detergent composition in the form of a solid, a second compartment comprising a second detergent composition in the form of a non-solid, and a third compartment comprising a third detergent composition in the form of a non-solid having a viscosity lower than the viscosity of the second detergent composition,
wherein the internal sealing web comprises at least a first internal sealing region arranged across the package to partition the first compartment and the second compartment, and a second internal sealing region arranged across the package to partition the second compartment and the third compartment,
wherein the first detergent composition is separated from the third detergent composition by the first internal sealing region, the second compartment and the second internal sealing region.

2. The multi-compartment package according to claim 1, wherein the third detergent composition has a lower viscosity than the second detergent composition.

3. The multi-compartment package according to claim 1, wherein the second detergent composition is in the form of a gel.

4. The multi-compartment package according to claim 1, wherein the external sealing web has a total area of less than 355 mm².

5. The multi-compartment package according to claim 1, wherein the external sealing web has a total area of between 250 and 355 mm².

6. The multi-compartment package according to claim 1, wherein the total area of the external sealing web and the total area of the internal sealing web are present in a ratio of between 2.55:1 and 3.55:1.

7. The multi-compartment package according to claim 1, wherein at least two of the first compartment, second compartment and third compartment have different relative heights.

8. The multi-compartment package according to claim 1, wherein the first compartment, second compartment and third compartment each have different relative heights.

9. The multi-compartment package according to claim 1, wherein the first compartment, second compartment and third compartment provide a stepped height profile in at least one direction.

10. The multi-compartment package according to claim 1, wherein the first compartment has a height greater than the height of the second compartment and greater than the height of the third compartment.

11. The multi-compartment package according to claim 1, wherein the third compartment has a height less than the height of the first compartment and less than the height of the second compartment.

12. The multi-compartment package according to claim 1, wherein at least one of the first internal sealing region and second internal sealing region is a substantially continuously curved shape.

13. The multi-compartment package according to claim 1, wherein the first internal sealing region and second internal sealing region are a substantially continuously curved shape.

14. The multi-compartment package according to claim 1, wherein the multi-compartment package is free of any substantially continuously straight internal sealing regions.

15. The multi-compartment package according to claim 1, wherein the package comprises a single plane of symmetry.

16. The multi-compartment package according to claim 1, wherein the multi-compartment package has a substantially square shape.

17. The multi-compartment package according to claim 16, wherein the third compartment is substantially located in a corner of the substantially square shaped multi-compartment package.

18. A packaging unit comprising a plurality of multi-compartment packages according to claim 1.

19. The packaging unit according to claim 18, wherein the plurality of multi-compartment packages comprises:
a first multi-compartment package; and
a second multi-compartment package,
wherein the first compartment of each package has a first height, the second compartment of each package has a second height less than the first height, and the third compartment of each package has a third height less than the first and second heights.

20. The packaging unit according to claim 19, wherein the first multi-compartment package and the second multi-compartment package are arranged to overlap one another by superposition of the first compartment of the first multi-compartment package with the third compartment of the second multi-compartment package, and superposition of the third compartment of the first multi-compartment package with the first compartment of the second multi-compartment package.

21. The packaging unit according to claim 18, wherein the plurality of multi-compartment packages form a bi-layer arrangement of multi-compartment packages within the packaging unit, wherein the bi-layer arrangement comprises a first layer of multiple multi-compartment packages and a second layer of multiple multi-compartment packages superposed thereon.

22. A method of using a multi-compartment package according to claim 1, comprising
treating or washing soiled kitchenware.
